(19) United States
(12) Patent Application Publication
(10) Pub. No.: US 2016/0129462 A1
(43) Pub. Date: May 12, 2016

(54) RECEPTACLE HOLDING AND WARMING APPARTUS

(71) Applicants: John Peter, Quincy, IL (US); Andrew Peter, Quincy, IL (US)

(72) Inventors: John Peter, Quincy, IL (US); Andrew Peter, Quincy, IL (US)

(21) Appl. No.: 14/535,606

(22) Filed: Nov. 7, 2014

(51) Int. Cl. B05B 11/00

(52) U.S. Cl. CPC B05B 11/0002

(57) ABSTRACT

A receptacle holding and warming apparatus for holding a conventional refillable spray bottle and warming its contents. The receptacle holding and warming apparatus comprises a support housing defining a cylindrical body having an open top end and a closed bottom end, two heating elements, defined as a central heating element section and a side heating element section, and a power supply connector for supplying electricity to the heating elements. In use, a spray bottle placed in the support housing rests on four platform tabs above the heating elements, exposing its surface to air heated by the heating elements without requiring it to contact the heating elements. In the preferred embodiment, the receptacle holding and warming apparatus measures 3.5 inches in diameter and is 4 inches tall.

### BACKGROUND OF THE INVENTION

1. Field of the Invention

This invention relates generally to heating devices and, more particularly, to a spray bottle holding and warming apparatus for maintaining a set temperature of the spray bottle.

2. Description of the Prior Art

The use and design of conventional refillable spray bottles for spraying water in various scenarios is well known. For example, it is common in barbershops and other hair styling salons for water (or other liquids) to be sprayed on the head or hair of a customer. In such situations, however, the water is generally kept at room temperature and when sprayed on a customer, the water at that temperature often feels cold and is shocking to the customer. Furthermore, there exist other water spraying tasks that require the use warm water (relative to room temperature), such as adding humidity to an iguana or terrarium. Therefore, a problem which still exists is that existing refillable water spray bottles are unable to maintain water at an elevated temperature, ready for use at any given time. Conventional warming and/or heating devices, such as those for candles, often lack the structure to efficiently warm the contents of a spray bottle or are otherwise not designed to warm the contents of a spray bottle without introducing too much heat to the bottle. Thus, there remains a need for a receptacle holding and warming apparatus in which a refillable spray bottle could be supported and subjected to a heating element for warming its contents. It would be helpful if such a receptacle holding and warming apparatus allowed the contents of a refillable spray to be held at a constant temperature while the spray bottle was not in use. It would be additionally desirable for such a receptacle holding and warming apparatus to supply heat at the bottom of the bottle along with on the sides to enable it to more efficiently maintain the temperature of the spray bottle contents.

The Applicant's invention described herein provides for a receptacle holding and warming apparatus adapted to hold a spray bottle while warm its contents. The primary components in Applicant's receptacle holding and warming apparatus are a support housing, two heating elements, and a thermostat integrated power supply connector. When in operation, the receptacle holding and warming apparatus enables a user to place and temporarily store a spray bottle in a housing that will maintain the contents of the bottle at a constant temperature. As a result, many of the limitations imposed by prior art structures are removed.

### SUMMARY OF THE INVENTION

A receptacle holding and warming apparatus for holding a conventional refillable spray bottle and warming its contents. The receptacle holding and warming apparatus comprises a support housing defining a cylindrical body having an open top end and a closed bottom end, two heating elements, defined as a central heating element section and a side heating element section, and a power supply connector for supplying electricity to the heating elements. In use, a spray bottle placed in the support housing rests on four platform tabs above the heating elements, exposing its surface to air heated by the heating elements without requiring it to contact the heating elements. In the preferred embodiment, the receptacle holding and warming apparatus measures 3.5 inches in diameter and is 4 inches tall.

It is an object of this invention to provide a receptacle holding and warming apparatus in which a refillable spray bottle could be supported and subjected to a heating element for warming its contents.

It is another object of this invention to provide a receptacle holding and warming apparatus that allows the contents of a refillable spray to be held at a constant temperature while the spray bottle was not in use.

It is yet another object of this invention to provide a receptacle holding and warming apparatus that supplies heat at the bottom of the bottle along with on the sides to enable it to more efficiently maintain the temperature of the spray bottle contents.

These and other objects will be apparent to one of skill in the art.

### BRIEF DESCRIPTION OF THE DRAWINGS

FIG. 1 is a side perspective view of a receptacle holding and warming apparatus built in accordance with the present invention.

FIG. 2 is a top plan view of a receptacle holding and warming apparatus built in accordance with the present invention.

### DETAILED DESCRIPTION OF THE INVENTION

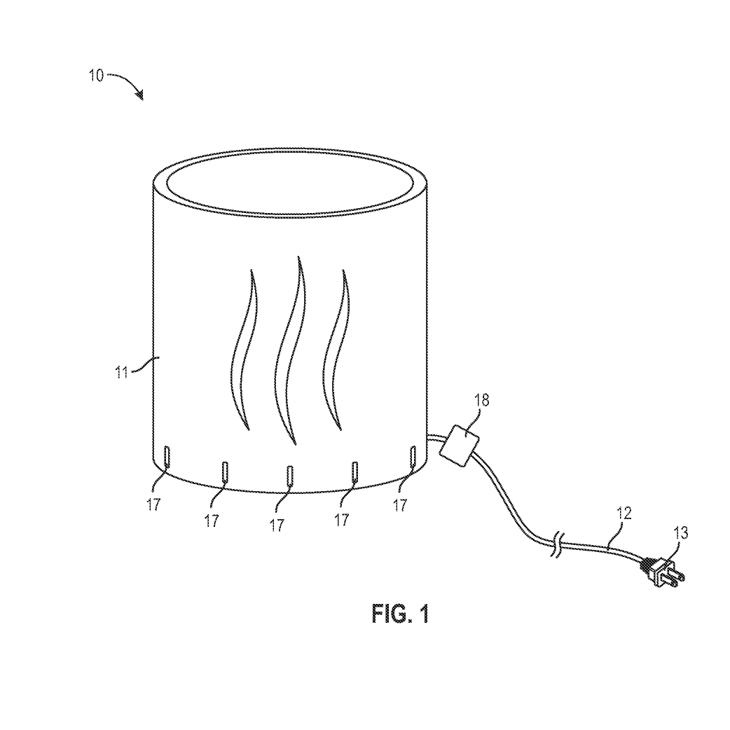

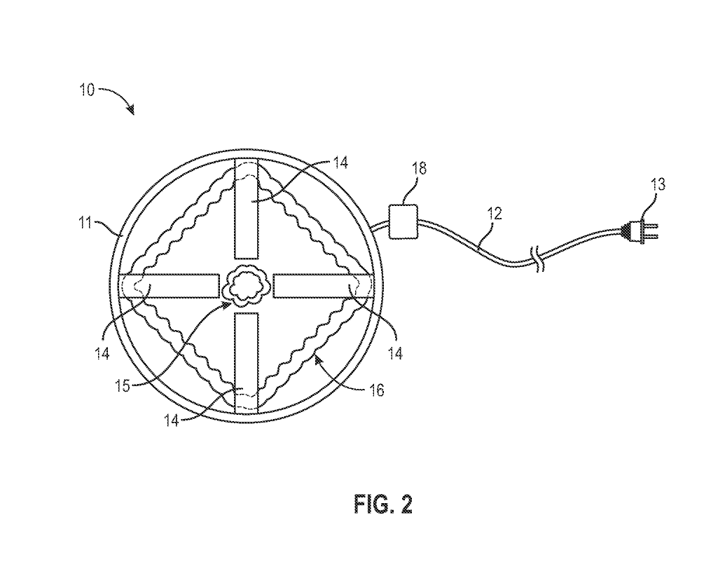

Referring now to the drawings and in particular FIGS. 1 and 2, a receptacle holding and warming apparatus 10 in accordance with the present invention is shown having a support housing 11, a heating element, and a power supply connector, defined in the preferred embodiment as an electrical cord 12 with a plug 13 at one end and connected to the support housing at the opposite end.

The support housing 11 defines a cylindrical body having an open top end and a closed bottom end. The support housing 11 is sized to allow a conventional refillable spray bottle (not shown) to be placed and held therein, with the bottom of such a spray bottle entering the open top of the support housing 11 and continuing into it until it contacts four rigid platform tabs 14 that extend out from the side walls of the support housing 11 that, in the preferred embodiment, extend orthogonally from the side walls four fifths of the way down the support housing 11. In this regard, the platform tabs 14 provide a platform means for supporting a spray bottle above the bottom of the support housing 11.

Disposed above the bottom of the support housing but below the platform tabs 14 are a central heating element section 15 and a side heating element section 16, each electrically connected to the electrical cord 12. When electrical power is supplied through the electrical cord, the central heating element section 15 and side heating element section 16 generate heat that warms the air in their vicinity, causing the air to rise into the bottom of a spray bottle resting on the platform tabs 14 and along the sides of such a spray bottle, respectively. In this regard, the central heating element section 15 provides a heating means for warming the bottom of a spray bottle and the side heating element section 16 provides a heating means for warming the sides of a spray bottle. In the preferred embodiment, air slits 17 are included in the support housing 11 along its bottom surface to allow cooler ambient air to enter the near the bottom of the support housing 11 where it is subsequently warmed and rises.

Integrated with the electrical cord 12 is a thermostat 18 that provides a manual interface for raising or lowering the heat output of the central heating element section 15 and side heating element section 16.

It is contemplated that in the preferred embodiment, conventional metal heating elements are employed for both the central heating element section 15 and side heating element section 16. In alternate embodiments, ceramic heating elements may be employed in the alternative to or in conjunction with metal heating elements.

In an alternate embodiment, a circular platform (not shown) is included on top of the platform tabs 14 to provide a broader surface on which a spray bottle can rest, particularly when smaller spray bottles are desired to be warmed. In one embodiment, the platform includes a grated surface that allows heated air to more freely pass through it.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A receptacle holding and warming apparatus for holding and warming a conventional spray bottle, comprising:
a support housing having an open top end, a closed bottom end and side walls, wherein the support housing includes at least one platform member configured to support a conventional spray bottle above the bottom end of the support housing;
at least one heating element section disposed beneath the platform member, wherein said at least one heating element section generates heat when supplied electrical power; and
a power supply connected to the support housing and configured to selectively supply electrical power to the at least one heating element section.

2. The receptacle holding and warming apparatus of claim 1, wherein the support housing defines a cylindrical body having a having an open top end and a closed bottom end.

3. The receptacle holding and warming apparatus of claim 1, wherein at least two platform members, each defined as a discrete, elongated platform tab that extends orthogonally from the side walls of the support housing are disposed on said support housing.

4. The receptacle holding and warming apparatus of claim 3, wherein four platform members are disposed on said support housing.

5. The receptacle holding and warming apparatus of claim 1, wherein two discrete heating element sections are disposed beneath the at least one platform member.

6. The receptacle holding and warming apparatus of claim 5, wherein the heating element sections define a central heating element section for warming the bottom of a spray bottle and the side heating element section for warming the sides of a spray bottle.

7. The receptacle holding and warming apparatus of claim 1, wherein the power supply defines an electrical having an integrated thermostat.

8. A receptacle holding and warming apparatus for holding and warming a conventional spray bottle, comprising:
a support housing having an open top end, a closed bottom end and side walls, wherein the support housing includes a platform means for supporting a spray bottle above the bottom of the support housing;
at least one of a heating means for warming the bottom of a spray bottle integral with the support housing and a heating means for warming the sides of a spray bottle integral with the support housing;
a power supply connected to the support housing and configured to selectively supply electrical power to the at least one of a heating means for warming the bottom of a spray bottle and a heating means for warming the sides of a spray bottle.

9. The receptacle holding and warming apparatus of claim 1, wherein both the heating means for warming the bottom of a spray bottle and the heating means for warming the sides of a spray bottle are integral with the support housing.
